(19) United States
(12) Patent Application Publication
(10) Pub. No.: US 2022/0388841 A1
(43) Pub. Date: Dec. 8, 2022

(54) REFORMING DEVICE AND REFORMING SYSTEM

(71) Applicant: KABUSHIKI KAISHA TOYOTA JIDOSHOKKI, Kariya-shi, Aichi-ken (JP)

(72) Inventors: Hiroyasu KAWAUCHI, Aichi-ken (JP); Hideaki SUZUKI, Aichi-ken (JP)

(73) Assignee: KABUSHIKI KAISHA TOYOTA JIDOSHOKKI, Kariya-shi, Aichi-ken (JP)

(21) Appl. No.: 17/769,905

(22) PCT Filed: Sep. 28, 2020
(86) PCT No.: PCT/JP2020/036563

§ 371 Date: Apr. 18, 2022

(30) Foreign Application Priority Data
Oct. 21, 2019 (JP) 2019-191981
Dec. 16, 2019 (JP) 2019-226676
Jul. 10, 2020 (JP) 2020-119281

(51) Int. Cl. C01B 3/04

(52) U.S. Cl. CPC C01B 3/047; C01B 2203/0244; C01B 2203/0811; C01B 2203/0255; C01B 2203/1211; C01B 2203/169; C01B 2203/1619; C01B 2203/1623

(57) ABSTRACT

A reforming device is provided with: a reformer in which an ammonia gas is burnt by air to generate heat to reform the ammonia gas utilizing the generated heat; a supply pipe through which a gas comprising the ammonia gas and air to be fed to the reformer flows; a gas inlet which is arranged in the supply pipe and through which the ammonia gas and air are introduced into the inside of the supply pipe in such a manner that a tubular flow can be generated; an igniter which can ignite the ammonia gas introduced into the inside of the supply pipe through the gas inlet; and an ammonia gas inlet which is arranged in the supply pipe on a side closer to the reformer than the gas inlet and through which the ammonia gas is introduced into the inside of the supply pipe.

### TECHNICAL FIELD

The present invention relates to a reforming device and a reforming system.

### BACKGROUND ART

For example, Patent Literature 1 discloses a reforming device. The reforming device disclosed in Patent Literature 1 includes an ammonia combustion catalyst combusting ammonia to generate heat, and an ammonia cracking catalyst cracking the ammonia using the heat generated by the ammonia combustion catalyst to generate gas containing hydrogen and nitrogen.

### CITATION LIST

### Patent Literature

Patent Literature 1: Japanese Patent Application Publication No. 2010-240646

### SUMMARY OF INVENTION

### Technical Problem

In the above-described background art, at a start of the reforming device, ammonia reacts with oxygen using the ammonia combustion catalyst, which ignites and combusts the ammonia. However, the start of the reforming device takes a long time when a start of ignition of the ammonia takes a long time.

An object of the present invention is to provide a reforming device and a reforming system capable of shortening a starting time.

### Solution to Problem

A reforming device according to an aspect of the present invention includes: a reformer configured to reform fuel gas using heat generated by combustion of the fuel gas with oxidizing gas; a supply pipe that is connected to the reformer, and through which gas containing the fuel gas and the oxidizing gas to be supplied to the reformer flows; a first gas inlet that is provided in the supply pipe, and from which the fuel gas and the oxidizing gas are introduced so as to form a tubular flow inside the supply pipe; an igniter that is mounted to the supply pipe, and ignites the fuel gas introduced into the supply pipe from the first gas inlet; and a second gas inlet that is provided in the supply pipe, closer to the reformer than the first gas inlet is, and from which the fuel gas is introduced into the supply pipe.

At a start of the above-described reforming device, the fuel gas and the oxidizing gas are introduced into the supply pipe from the first gas inlet and the igniter is turned on, which ignites and combusts the fuel gas. At this time, the fuel gas and the oxidizing gas are introduced into the supply pipe so as to form a tubular flow. Therefore, when the fuel gas and the oxidizing gas are in the tubular flow state, the fuel gas is ignited to form a tubular flame, so that high-temperature combustion gas swirlingly flows toward the reformer inside the supply pipe. The fuel gas is introduced into the supply pipe from the second gas inlet. The fuel gas heated by receiving heat (combustion heat) from the high-temperature combustion gas is supplied to the reformer. In the reformer, the fuel gas combusts and is reformed to generate reformed gas containing hydrogen. As such, the high-temperature combustion heat generated by combustion of the fuel gas ignited by the igniter is utilized, which shortens a time until ignition of the fuel gas to be reformed. This can shorten a starting time of the reforming device.

The reforming device may further include a third gas inlet that is provided in the supply pipe, and from which the oxidizing gas is introduced into the supply pipe.

In this configuration, since the oxidizing gas is introduced into the supply pipe from the third gas inlet, a flow rate of the oxidizing gas to be supplied to the reformer can be easily adjusted.

The third gas inlet may be provided in the supply pipe, closer to the reformer than the second gas inlet is.

In this configuration, the fuel gas introduced into the supply pipe from the second gas inlet receives the heat from the combustion gas, thereby causing a temperature drop of the combustion gas. The oxidizing gas introduced into the supply pipe from the third gas inlet receives the heat from the combustion gas containing the fuel gas, thereby causing the temperature drop of the combustion gas containing the fuel gas. This results in an effective temperature drop of the high-temperature combustion gas generated by combustion of the fuel gas ignited by the igniter.

The first gas inlet may introduce the fuel gas and the oxidizing gas into the supply pipe in a tangential direction of an inner circumferential surface of the supply pipe.

In this configuration, since the fuel gas and the oxidizing gas are introduced into the supply pipe in the tangential direction of the inner circumferential surface of the supply pipe, the fuel gas and the oxidizing gas form the tubular flow inside the supply pipe in a short time.

The second gas inlet may introduce the fuel gas into the supply pipe in the tangential direction of the inner circumferential surface of the supply pipe, and the third gas inlet may introduce the oxidizing gas into the supply pipe in the tangential direction of the inner circumferential surface of the supply pipe.

In this configuration, the fuel gas and the oxidizing gas are introduced into the supply pipe from the second gas inlet and the third gas inlet respectively, and form the tubular flow, so that the fuel gas and the oxidizing gas swirlingly flow toward the reformer. Therefore, the fuel gas and the oxidizing gas are mixed in the same flow with respect to the combustion gas flowing in the tubular flow state. This makes a long passage for mixing the fuel gas and the oxidizing gas, and the combustion gas. Accordingly, in the reformer, a mixing ratio of the fuel gas and the oxidizing gas is equalized, which easily ignite and combust the fuel gas.

A reforming system according to another aspect of the present invention includes: a reforming device; a fuel gas supply unit configured to supply fuel gas to the reforming device; and an oxidizing gas supply unit configured to supply oxidizing gas to the reforming device. The reforming device includes: a reformer configured to reform the fuel gas using heat generated by combustion of the fuel gas with the oxidizing gas; a supply pipe that is connected to the reformer, and through which gas containing the fuel gas and the oxidizing gas to be supplied to the reformer flows; a first gas inlet that is provided in the supply pipe, and from which the fuel gas and the oxidizing gas are introduced so as to form a tubular flow inside the supply pipe; an igniter that is mounted to the supply pipe, and ignites the fuel gas introduced into the supply pipe from the first gas inlet; and a second gas inlet that is provided in the supply pipe, closer to the reformer than the first gas inlet is, and from which the fuel gas is introduced into the supply pipe.

In this reforming system, at a start of the reforming device, the fuel gas and the oxidizing gas are introduced into the supply pipe from the first gas inlet and the igniter is turned on, which ignites and combusts the fuel gas. At this time, the fuel gas and the oxidizing gas are introduced into the supply pipe so as to form the tubular flow inside the supply pipe. Therefore, when the fuel gas and the oxidizing gas are in the tubular flow state, the fuel gas is ignited to form a tubular flame, which allows high-temperature combustion gas to swirlingly flow toward the reformer inside the supply pipe. The fuel gas is introduced into the supply pipe from the second gas inlet. This fuel gas heated by receiving the heat (combustion heat) from the high-temperature combustion gas is supplied to the reformer. In the reformer, the fuel gas combusts and is reformed to generate the reformed gas containing hydrogen. As described above, high-temperature combustion heat is generated by combustion of the fuel gas ignited by the igniter, and such high-temperature combustion heat is utilized, which shortens a time until ignition of the fuel gas to be reformed. This can shorten a starting time of the reforming device.

The reforming device may further include a third gas inlet that is provided in the supply pipe, and from which the oxidizing gas is introduced into the supply pipe.

In this configuration, the oxidizing gas is introduced into the supply pipe from the third gas inlet, which can easily adjust a flow rate of the oxidizing gas to be supplied to the reformer.

The reforming system may further include a control unit configured to control the fuel gas supply unit, the oxidizing gas supply unit, and the igniter. The fuel gas supply unit may have a first fuel gas valve configured to control a flow rate of the fuel gas to be supplied to the first gas inlet, and a second fuel gas valve configured to control a flow rate of the fuel gas to be supplied to the second gas inlet. The oxidizing gas supply unit may have a first oxidizing gas valve configured to control a flow rate of the oxidizing gas to be supplied to the first gas inlet and a second oxidizing gas valve configured to control a flow rate of the oxidizing gas to be supplied to the third gas inlet. The control unit may include a first controller configured to execute, at a start of the reforming device, a control process in which the first fuel gas valve, the second fuel gas valve, and the second oxidizing gas valve are opened and the igniter is turned on, and a second controller configured to control, after execution of the control process by the first controller, the first fuel gas valve and the first oxidizing gas valve so as to be closed.

In this configuration, at a start of the reforming device, the first fuel gas valve and the first oxidizing gas valve are controlled so as to be opened; thereafter, the first fuel gas valve and the first oxidizing gas valve are controlled so as to be closed. Therefore, after the reforming device starts, introduction of the fuel gas and the oxidizing gas as the starter gas into the supply pipe stops, which can prevent excessive combustion of the fuel gas as the starter gas.

The reforming system may further include a temperature detector configured to detect a temperature of the reformer. After execution of the control process by the first controller, the second controller may control the first fuel gas valve and the first oxidizing gas valve so as to be closed when the temperature of the reformer detected by the temperature detector becomes equal to or higher than a specified temperature.

In this configuration, when the temperature of the reformer becomes equal to or higher than the specified temperature, the first fuel gas valve and the first oxidizing gas valve are controlled so as to be closed. Thus, introduction of the fuel gas and the oxidizing gas as the starter gas into the supply pipe stops at an appropriate timing of combustion and reforming of the fuel gas. This can further prevent excessive combustion of the fuel gas.

The reforming system may further include a temperature detector configured to detect a temperature of the reformer having a catalyst combusting the fuel gas. The first controller may execute a control process in which the first fuel gas valve, the first oxidizing gas valve, and the second fuel gas valve are opened and the igniter is turned on; thereafter, the first controller may execute the control process in which the second oxidizing gas valve is opened when the temperature of the reformer detected by the temperature detector becomes equal to or higher than a specified temperature.

In this configuration, the fuel gas and the oxidizing gas as the starter gas are introduced into the supply pipe from the first gas inlet, and the fuel gas to be reformed is introduced into the supply pipe from the second gas inlet. After that, the second oxidizing gas valve is controlled so as to be opened when the temperature of the reformer becomes equal to or higher than the specified temperature. Thus, even when a catalyst combusting the fuel gas easily oxidizes, the oxidizing gas is not introduced into the supply pipe from the third gas inlet until the temperature of the reformer becomes equal to or higher than the specified temperature. This can prevent oxidization and deterioration of the catalyst. When the temperature of the reformer becomes equal to or higher than the specified temperature, the first fuel gas valve and the first oxidizing gas valve are controlled so as to be closed. Therefore, introduction of the fuel gas and the oxidizing gas as the starter gas into the supply pipe stops at an appropriate timing of combustion and reforming of the fuel gas. This can further prevent excessive combustion of the fuel gas.

The reforming system may further include a control unit configured to control the fuel gas supply unit, the oxidizing gas supply unit, and the igniter. The fuel gas supply unit may have a first fuel gas valve configured to control a flow rate of the fuel gas to be supplied to the first gas inlet, and a second fuel gas valve configured to control a flow rate of the fuel gas to be supplied to the second gas inlet. The oxidizing gas supply unit may have an oxidizing gas valve configured to control a flow rate of the oxidizing gas to be supplied to the first gas inlet. The control unit may include a first controller configured to execute, at a start of the reforming device, a control process in which the first fuel gas valve, the second fuel gas valve, and the oxidizing gas valve are opened and the igniter is turned on, and a second controller configured to control, after execution of the control process by the first controller, the first fuel gas valve so as to be closed.

In this configuration, at a start of the reforming device, the first fuel gas valve and the oxidizing gas valve are controlled so as to be opened; thereafter, the first fuel gas valve is controlled so as to be closed. Thus, after the reforming device starts, introduction of the fuel gas as the starter gas into the supply pipe stops, which can prevent excessive combustion of the fuel gas as the starter gas. Since the third gas inlet for introducing the oxidizing gas into the supply pipe is unnecessary, a valve for controlling a flow rate of the oxidizing gas to be supplied to the third gas inlet is unnecessary. This can simplify a configuration of the oxidizing gas supply unit.

### Advantageous Effects of Invention

According to the present invention, a starting time of the reforming device can be shortened.

### BRIEF DESCRIPTION OF DRAWINGS

FIG. 1 is a schematic configuration diagram of a reforming system including a reforming device according to a first embodiment of the present invention.

FIG. 2 is a configuration diagram of the reforming device according to the first embodiment of the present invention.

FIG. 3 is a cross-sectional view taken along a line III-III of FIG. 2.

FIG. 4 is a cross-sectional view taken along a line IVa-IVa of FIG. 2 and a cross-sectional view taken along a line IVb-IVb of FIG. 2.

FIG. 5 is a flowchart of details of steps of a control process executed by a control unit illustrated in FIG. 2.

FIG. 6 is a timing diagram illustrating an operation of the reforming system illustrated in FIG. 1.

FIG. 7 is a configuration diagram of a reforming device according to a second embodiment of the present invention.

FIG. 8 is a flowchart of details of steps of a control process executed by a control unit in a reforming system including a reforming device according to a third embodiment of the present invention.

FIG. 9 is a timing diagram illustrating an operation of the reforming system including the control unit configured to execute the control process illustrated in FIG. 8.

FIG. 10 is a schematic configuration diagram of a reforming system including a reforming device according to a fourth embodiment of the present invention.

FIG. 11 is a configuration diagram of the reforming device according to the fourth embodiment of the present invention.

FIG. 12 is a flowchart of details of steps of a control process executed by a control unit illustrated in FIG. 10.

### DESCRIPTION OF EMBODIMENTS

Hereinafter, embodiments of the present invention will be described in detail with reference to the accompanying drawings. In the drawings, the same or equivalent parts are designated by the same reference numerals, and the redundant descriptions thereof are omitted.

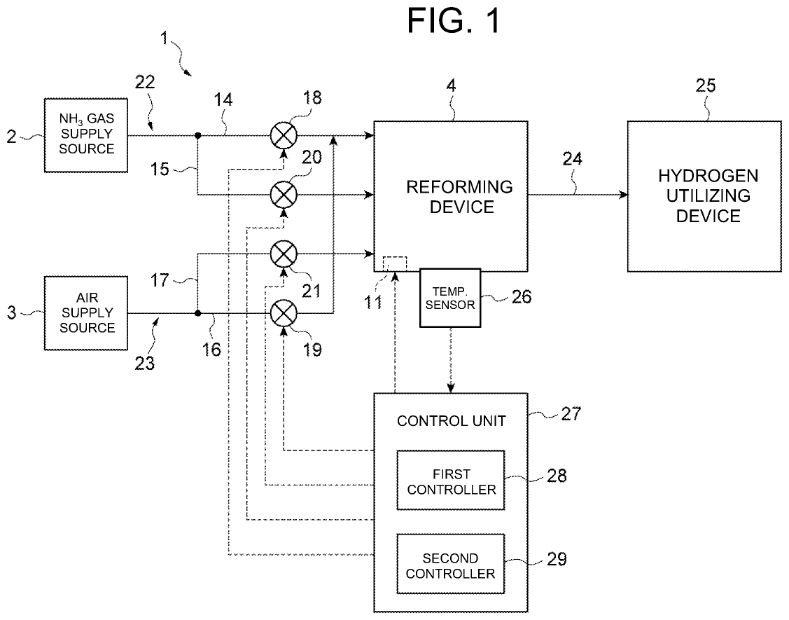

FIG. 1 is a schematic configuration diagram of a reforming system including a reforming device according to a first embodiment of the present invention. In FIG. 1, a reforming system 1 includes an ammonia gas supply source 2, an air supply source 3, and a reforming device 4 of the present embodiment.

The ammonia gas supply source 2 generates ammonia gas (NH₃ gas) serving as fuel gas. The ammonia gas supply source 2 has an ammonia tank storing liquid ammonia and a vaporizer vaporizing the liquid ammonia to generate the ammonia gas, which are not illustrated.

The air supply source 3 generates air serving as oxidizing gas. A blower or the like is used as the air supply source 3.

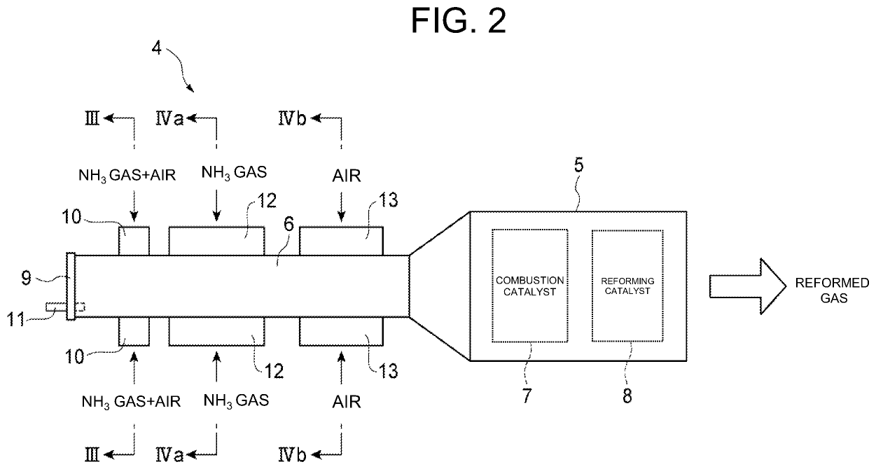

FIG. 2 is a configuration diagram of the reforming device 4 of the present embodiment. In FIG. 2, the reforming device 4 is a device for reforming the ammonia gas. The reforming device 4 includes a reformer 5 and a supply pipe 6 connected to the reformer 5.

The reformer 5 reforms the ammonia gas using heat generated by combustion of the ammonia gas with the air, so that reformed gas containing hydrogen is generated. The reformer 5 has a combustion catalyst 7 combusting the ammonia gas and a reforming catalyst 8 cracking the ammonia gas into hydrogen using heat generated by the combustion catalyst 7. The reforming catalyst 8 is disposed on a downstream side (an opposite side to the supply pipe 6) of the combustion catalyst 7.

The combustion catalyst 7 is, for example, a catalyst in which palladium and copper are supported on zeolite, or CuO/10Al₂O₃.2B₂O₃. The combustion catalyst 7 combusts the ammonia gas in a temperature range of 200° C. to 400° C., for example. The reforming catalyst 8 is, for example, Ru/CeO₂, Ru/ZrO₂, Ru/MgO, Ru/Al₂O₃, or Ru/SiO₂. The reforming catalyst 8 cracks the ammonia gas into hydrogen in a temperature range of 250° C. to 500° C., for example.

The supply pipe 6 is a cylindrical pipe through which gas containing the ammonia gas and the air to be supplied to the reformer 5 flows. An opening of the supply pipe 6, at a distal end thereof, is closed by a lid 9. The distal end of the supply pipe 6 is an end opposite to a part of the supply pipe 6 connected to the reformer 5.

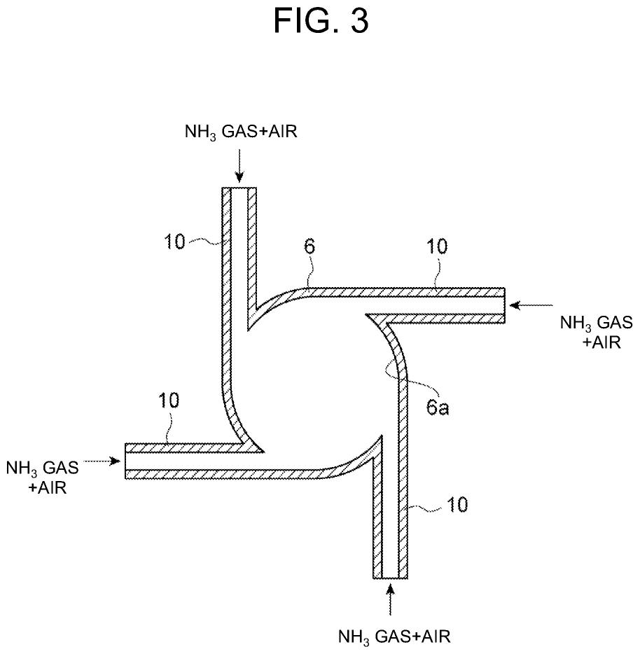

As illustrated in FIG. 3, the supply pipe 6 has, at the distal end thereof, four gas inlets 10 (first gas inlets) from which the ammonia gas and the air as starter gas are introduced into the supply pipe 6. Each of the gas inlets 10 introduces the ammonia gas and the air into the supply pipe 6 so as to form a tubular flow inside the supply pipe 6. Specifically, the gas inlets 10 are arranged at equal intervals in a tangential direction of an inner circumferential surface 6a of the supply pipe 6. Therefore, the ammonia gas and the air are introduced into the supply pipe 6 in the tangential direction of the inner circumferential surface 6a of the supply pipe 6. At this time, the ammonia gas and the air in a mixed state are introduced into the supply pipe 6. Here, the ammonia gas and the air introduced into the supply pipe 6 from the gas inlets 10 are considered as starter ammonia gas and starter air, respectively.

An igniter 11 that ignites the starter ammonia gas introduced into the supply pipe 6 from the gas inlets 10 is mounted to the distal end of the supply pipe 6. The igniter 11 is fixed to the lid 9. The igniter 11 is a glow plug or a spark plug, for example.

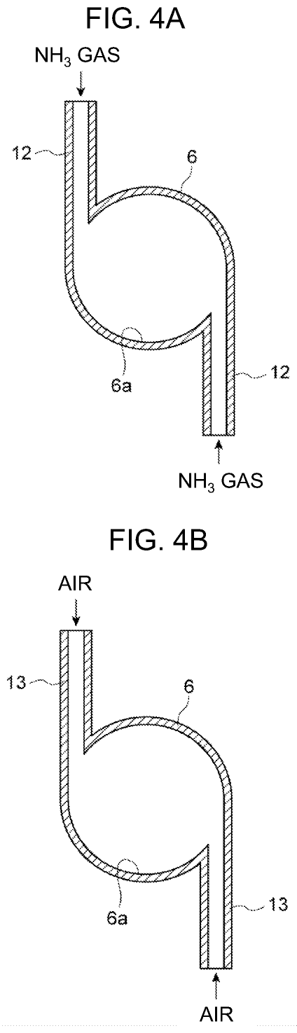

As illustrated in FIG. 4(a), two ammonia gas inlets 12 (second gas inlets) from which the ammonia gas is introduced into the supply pipe 6 are provided on a downstream side (on the reformer 5 side) of the gas inlets 10 provided in the supply pipe 6. Each of the ammonia gas inlets 12 introduces the ammonia gas into the supply pipe 6 so as to form a tubular flow inside the supply pipe 6. Specifically, the ammonia gas inlets 12 are arranged in the tangential direction of the inner circumferential surface 6a of the supply pipe 6. Therefore, the ammonia gas is introduced into the supply pipe 6 in the tangential direction of the inner circumferential surface 6a of the supply pipe 6. Here, the ammonia gas introduced into the supply pipe 6 from the ammonia gas inlets 12 is considered as main ammonia gas for reforming.

As illustrated in FIG. 4(b), two air inlets 13 (third gas inlets) from which the air is introduced into the supply pipe 6 are provided on a downstream side of the ammonia gas inlets 12 in the supply pipe 6. Each of the air inlets 13 introduces the air into the supply pipe 6 so as to form a tubular flow inside the supply pipe 6. Specifically, the air inlets 13 are arranged in the tangential direction of the inner circumferential surface 6a of the supply pipe 6. Therefore, the air is introduced into the supply pipe 6 in the tangential direction of the inner circumferential surface 6a of the supply pipe 6. The air inlets 13 are arranged at respective positions corresponding to the ammonia gas inlets 12, for example. Here, the air introduced into the supply pipe 6 from the air inlets 13 is considered as main air for reforming.

The gas inlets 10, the ammonia gas inlets 12, and the air inlets 13 may be provided separately from the supply pipe 6, or may be integrated with the supply pipe 6.

Returning to FIG. 1, the ammonia gas supply source 2 and the reforming device 4 are connected through ammonia gas flow passages 14 and 15. The air supply source 3 and the reforming device 4 are connected through air flow passages 16 and 17.

One end of the ammonia gas flow passage 14 is connected to the ammonia gas supply source 2. The other end of the ammonia gas flow passage 14 is connected to each of the gas inlets 10 of the reforming device 4. The ammonia gas flow passage 14 is a flow passage through which the starter ammonia gas flows from the ammonia gas supply source 2 to the gas inlets 10. One end of the air flow passage 16 is connected to the air supply source 3. The other end of the air flow passage 16 is connected to the ammonia gas flow passage 14. The air flow passage 16 is a flow passage through which the starter air flows from the air supply source 3 to the gas inlets 10.

One end of the ammonia gas flow passage 15 is connected to the ammonia gas flow passage 14. The other end of the ammonia gas flow passage 15 is connected to each of the ammonia gas inlets 12 of the reforming device 4. The ammonia gas flow passage 15 is a flow passage through which the main ammonia gas flows from the ammonia gas supply source 2 to the ammonia gas inlets 12.

One end of the air flow passage 17 is connected to the air flow passage 16. The other end of the air flow passage 17 is connected to each of the air inlets 13 of the reforming device 4. The air flow passage 17 is a flow passage through which the main air flows from the air supply source 3 to the air inlets 13.

An ammonia gas valve 18 is disposed in the ammonia gas flow passage 14. The ammonia gas valve 18 is a first fuel gas valve controlling a flow rate of the starter ammonia gas to be supplied to the gas inlets 10. Here, the ammonia gas valve 18 functions as a starter ammonia gas valve. An air valve 19 is disposed in the air flow passage 16. The air valve 19 is a first oxidizing gas valve controlling a flow rate of the starter air supplied to the gas inlets 10. The air valve 19 functions as a starter air valve. An electromagnetic flow control valve is used as the ammonia gas valve 18 and the air valve 19.

An ammonia gas valve 20 is disposed in the ammonia gas flow passage 15. The ammonia gas valve 20 is a second fuel gas valve controlling a flow rate of the main ammonia gas supplied to the ammonia gas inlets 12. The ammonia gas valve 20 functions as a main ammonia gas valve. An air valve 21 is disposed in the air flow passage 17. The air valve 21 is a second oxidizing gas valve controlling a flow rate of the main air to be supplied to the air inlets 13. The air valve 21 functions as a main air valve. An electromagnetic flow control valve is used as the ammonia gas valve 20 and the air valve 21.

The ammonia gas supply source 2, the ammonia gas flow passages 14 and 15, and the ammonia gas valves 18 and 20 constitute an ammonia gas supply unit 22 (a fuel gas supply unit) that supplies the ammonia gas to the reforming device 4. The air supply source 3, the air flow passages 16 and 17, and the air valves 19 and 21 constitute an air supply unit 23 (an oxidizing gas supply unit) that supplies the air to the reforming device 4.

A hydrogen utilizing device 25 is connected to the reformer 5 of the reforming device 4 through the reformed gas flow passage 24. The reformed gas flow passage 24 is a flow passage through which the reformed gas generated by the reformer 5 flows toward the hydrogen utilizing device 25.

The hydrogen utilizing device 25 is a device for utilizing hydrogen contained in the reformed gas. The hydrogen utilizing device 25 may be a combustor such as an ammonia engine or an ammonia gas turbine, which use the ammonia as fuel, or a fuel cell that generates electricity by a chemical reaction between hydrogen and oxygen in the air.

The reforming system 1 includes a temperature sensor 26 and a control unit 27. The temperature sensor 26 is a temperature detector that detects a temperature of the reformer 5. The temperature sensor 26 may detect, for example, a temperature of gas flowing into the combustion catalyst 7 or a temperature of the reforming catalyst 8 or the combustion catalyst 7.

The control unit 27 includes a CPU, a RAM, a ROM, an input-output interface, and the like. The control unit 27 controls the ammonia gas valves 18 and 20 of the ammonia gas supply unit 22, the air valves 19 and 21 of the air supply unit 23, and the igniter 11, based on a detection value of the temperature sensor 26. The control unit 27 has a first controller 28 and a second controller 29.

At a start of the reforming device 4, the first controller 28 executes a control process in which the ammonia gas valves 18 and 20, and the air valves 19 and 21 are opened and the igniter 11 is turned on.

After execution of the control process by the first controller 28, the second controller 29 controls the ammonia gas valve 18 and the air valve 19 so as to be closed. Specifically, after execution of the control process by the first controller 28, the second controller 29 controls the ammonia gas valve 18 and the air valve 19 so as to be closed when the temperature of the reformer 5 detected by the temperature sensor 26 becomes equal to or higher than a specified temperature.

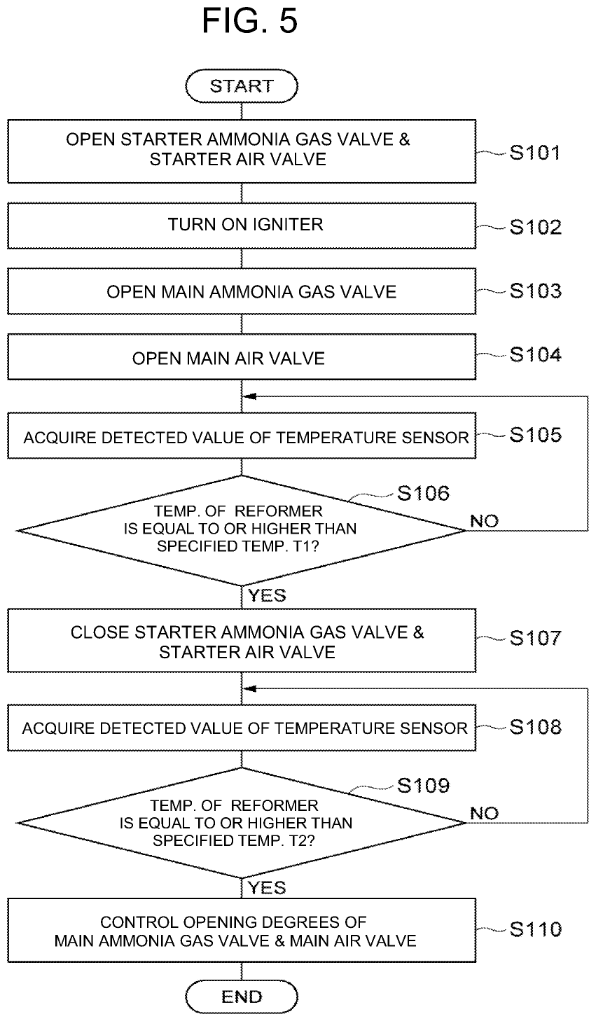

FIG. 5 is a flowchart of details of steps of a control process executed by the control unit 27 illustrated in FIG. 1. Before execution of the control process, all the ammonia gas valves 18 and 20 and the air valves 19 and 21 are fully closed.

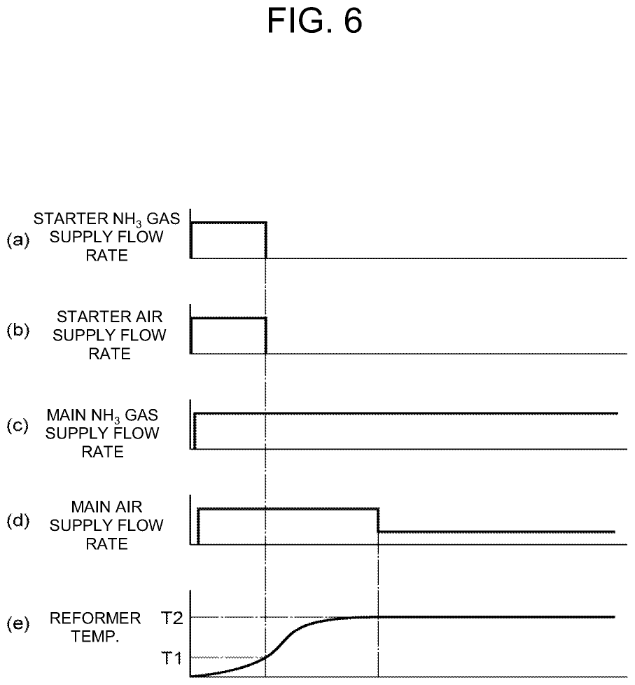

In FIG. 5, when a start of the reforming device 4 is instructed by a manual switch or the like, the control unit 27 controls the ammonia gas valve 18 and the air valve 19 so as to be opened (Step S101). Thus, the starter ammonia gas is supplied to the gas inlets 10 of the reforming device 4 (see FIG. 6(a)), and the starter air is supplied to the gas inlets 10 (see FIG. 6(b)). At this time, the ammonia gas valve 18 and the air valve 19 are controlled so that flow rates of the starter ammonia gas and the starter air to be supplied are equal to specified values (equivalent ratio, for example).

Next, the control unit 27 controls the igniter 11 so as to be turned on (Step S102). Thus, the igniter 11 is turned on, which ignites the starter ammonia gas.

Subsequently, the control unit 27 controls the ammonia gas valve 20 so as to be opened (Step S103). Thus, the main ammonia gas is supplied to the ammonia gas inlets 12 of the reforming device 4 (see FIG. 6(c)).

Then, the control unit 27 controls the air valve 21 so as to be opened (Step S104). Thus, the main air is supplied to the air inlets 13 of the reforming device 4 (see FIG. 6(d)). At this time, the air valve 21 and the ammonia gas valve 20 are controlled so that flow rates of the main ammonia gas and the main air to be supplied are equal to specified values (equivalence ratio, for example).

Next, the control unit 27 acquires a detected value of the temperature sensor 26 (Step S105). The control unit 27 determines whether the temperature of the reformer 5 is equal to or higher than a specified temperature T1 (see FIG. 6(e), Step S106). The specified temperature T1 is a temperature at which the main ammonia gas can combust (combustible temperature). When the control unit 27 determines that the temperature of the reformer 5 is lower than the specified temperature T1 (Step S106: NO), the control unit 27 executes Step S105 again.

When the control unit 27 determines that the temperature of the reformer 5 is equal to or higher than the specified temperature T1 (Step S106: YES), the control unit 27 controls the ammonia gas valve 18 and the air valve 19 so as to be closed (Step S107). At this time, it is desirable that the ammonia gas valve 18 and the air valve 19 be fully closed. Accordingly, supply of the starter ammonia gas to the gas inlets 10 of the reforming device 4 stops (see FIG. 6(a)), and supply of the starter air to the gas inlets 10 stops (see FIG. 6(b)).

Subsequently, the control unit 27 acquires a detected value of the temperature sensor 26 (Step S108). The control unit 27 determines whether the temperature of the reformer 5 is equal to or higher than a specified temperature T2 (see FIG. 6(e), Step S109). The specified temperature T2 is a temperature at which the main ammonia gas can be reformed (reformable temperature), and is higher than the specified temperature T1. When the control unit 27 determines that the temperature of the reformer 5 is lower than the specified temperature T2 (Step S109: NO), the control unit 27 executes Step S108 again.

When the control unit 27 determines that the temperature of the reformer 5 is equal to or higher than the specified temperature T2 (Step S109: YES), the control unit 27 controls opening degrees of the ammonia gas valve 20 and the air valve 21 (Step S110). At this time, the opening degrees of the ammonia gas valve 20 and the air valve 21 are controlled so that the flow rates of the main ammonia gas and the main air to be supplied are set for an appropriate reforming operation of the reformer 5 (see FIG. 6(c) and FIG. 6(d)).

Here, the first controller 28 executes the above-described Steps S101 to S104. The second controller 29 executes the above-described Steps S105 to S110.

In the above-described reforming system 1, when the start of the reforming device 4 is instructed, the ammonia gas valve 18 and the air valve 19 are opened, so that the starter ammonia gas and the starter air are supplied to the gas inlets 10 of the reforming device 4, as illustrated in FIG. 6(a) and FIG. 6(b). The starter ammonia gas and the starter air are introduced into the supply pipe 6 through the gas inlets 10. At this time, the starter ammonia gas and the starter air are introduced in the tangential direction of the inner circumferential surface 6a of the supply pipe 6 so as to form the tubular flow inside the supply pipe 6.

In this state, when the igniter 11 is turned on, the starter ammonia gas is ignited to form a tubular flame, whereby the starter ammonia gas combusts. Specifically, as indicated in the following formula, chemical reaction between ammonia and oxygen in the air occurs, so that combustion gas is generated (exothermic reaction).

NH₃+¾O₂→½N₂+ 3/2H₂O (A)

At this time, the temperature of the tubular flame rises to, for example, about 1000° C. to 1700° C. Thus, the above-described ammonia oxidation reaction generates high-temperature combustion gas. The high-temperature combustion gas swirlingly flows toward the reformer 5 inside the supply pipe 6.

After that, the ammonia gas valve 20 is opened, so that the main ammonia gas is supplied to the ammonia gas inlets 12 of the reforming device 4, as illustrated in FIG. 6(c). The main ammonia gas is introduced into the supply pipe 6 from the ammonia gas inlets 12. The temperature of the main ammonia gas is around a room temperature, which is sufficiently lower than the temperature of the combustion gas. Thus, heat is exchanged between the main ammonia gas and the combustion gas. Specifically, the main ammonia gas is heated by receiving the heat from the combustion gas and cools the combustion gas. At this time, the temperature of the combustion gas containing the main ammonia gas drops below an ignition temperature of ammonia (for example, about 650° C. in the air). Therefore, a state of the main ammonia gas inside the supply pipe 6 does not shift to a combusting state.

After that, the air valve 21 is opened, so that the main air is supplied to the air inlets 13 of the reforming device 4, as illustrated in FIG. 6(d). Then, the main air is introduced into the supply pipe 6 from the air inlets 13. The temperature of the main air is also around the room temperature. Thus, heat is exchanged between the main air and the combustion gas containing the main ammonia gas. Specifically, the main air is heated by receiving the heat from the combustion gas containing the main ammonia gas and cools the combustion gas containing the main ammonia gas. At this time, the temperature of mixed gas of the main ammonia gas, the main air, and the combustion gas drops to about 200° C. to 400° C., for example.

When such mixed gas is introduced into the reformer 5, the temperature of the reformer 5 rises. As illustrated in FIG. 6(e), when the temperature of the reformer 5 reaches the specified temperature T1 (combustible temperature), the ammonia gas valve 18 and the air valve 19 are closed, so that supply of the starter ammonia gas and the starter air to the gas inlets 10 stops, as indicated in FIG. 6(a) and FIG. 6(b). Therefore, introduction of the starter ammonia gas and the starter air into the supply pipe 6 stops, which stops combustion of the starter ammonia gas.

When the temperature of the reformer 5 reaches the specified temperature T1 (combustible temperature), the main ammonia gas combusts using the combustion catalyst 7. Then, exothermic reaction of the above-described formula (A) occurs, so that the combustion gas is generated. The temperature of the reformer 5 further rises due to heat of the combustion gas (combustion heat).

When the temperature of the reformer 5 reaches the specified temperature T2 (reformable temperature), as illustrated in FIG. 6(c) and FIG. 6(d), the flow rates of the main ammonia gas and the main air to be respectively supplied to the ammonia gas inlets 12 and the air inlets 13 are adjusted, which adjusts the flow rates of the main ammonia gas and the main air to be introduced into the supply pipe 6. Here, the flow rate of the main air has decreased and the flow rate of the main ammonia gas has not changed, but the flow rates of both the main ammonia gas and the main air may be changed.

When the temperature of the reformer 5 reaches the specified temperature T2 (reformable temperature), the main ammonia gas is reformed using the reforming catalyst 8. Specifically, as indicated in the following formula, decomposition reaction of ammonia occurs (endothermic reaction), so that reformed gas containing hydrogen is generated. The reformed gas is supplied to the hydrogen utilizing device 25.

NH₃→ 3/2H₂+½N₂ (B)

As described above, in the present embodiment, at a start of the reforming device 4, the ammonia gas and the air as the starter gas are introduced into the supply pipe 6 from the gas inlets 10, and the igniter 11 is turned on, which ignites and combusts the ammonia gas. At this time, the starter gas is introduced into the supply pipe 6 so as to form the tubular flow inside the supply pipe 6. Therefore, when the starter gas is in the tubular flow state, the ammonia gas is ignited to form the tubular flame, which allows the high-temperature combustion gas to swirlingly flow toward the reformer 5 inside the supply pipe 6. The ammonia gas to be reformed is introduced into the supply pipe 6 from the ammonia gas inlets 12. This ammonia gas heated by receiving the heat (combustion heat) from the high-temperature combustion gas is supplied to the reformer 5. In the reformer 5, the ammonia gas combusts and is reformed to generate the reformed gas containing hydrogen. As described above, high-temperature combustion heat is generated by combustion of the ammonia gas as the starter gas ignited by the igniter 11, and such high-temperature combustion heat is utilized, which shortens a time until ignition of the ammonia gas to be reformed. This can shorten a starting time of the reforming device 4. This can also eliminate a heater and the like for heating the ammonia gas, the air, or the catalysts.

In the present embodiment, since the air is introduced into the supply pipe 6 from the air inlets 13, the flow rate of the air to be supplied to the reformer 5 can be easily adjusted.

In the present embodiment, the air inlets 13 are provided in the supply pipe 6, closer to the reformer 5 than the ammonia gas inlets 12 are. Thus, the ammonia gas introduced into the supply pipe 6 from the ammonia gas inlets 12 receives the heat from the combustion gas, thereby dropping the temperature of the combustion gas. The air introduced into the supply pipe 6 from the air inlets 13 receives the heat from the combustion gas containing the ammonia gas, thereby causing the temperature drop of the combustion gas containing the ammonia gas. Since specific heat of the ammonia gas is higher than that of the air, the ammonia gas can absorb heat at a flow rate of the ammonia gas smaller than that of the air. Thus, the temperature of the combustion gas largely drops due to heat absorption of the ammonia gas. This results in an effective temperature drop of the high-temperature combustion gas generated by combustion of the ammonia gas ignited by the igniter 11.

In the present embodiment, since the ammonia gas and the air are introduced into the supply pipe 6 in the tangential direction of the inner circumferential surface 6a of the supply pipe 6, the ammonia gas and the air form the tubular flow inside the supply pipe 6 in a short time.

In the present embodiment, the ammonia gas inlets 12 introduce the ammonia gas into the supply pipe 6 in the tangential direction of the inner circumferential surface 6a of the supply pipe 6, and the air inlets 13 introduce the air into the supply pipe 6 in the tangential direction of the inner circumferential surface 6a of the supply pipe 6. Thus, the ammonia gas and the air are introduced into the supply pipe 6 from the ammonia gas inlets 12 and the air inlets 13 respectively, and form the tubular flow, so that the ammonia gas and the air swirlingly flow toward the reformer 5. Therefore, the ammonia gas and the air are mixed in the same flow with respect to the combustion gas flowing in the tubular flow state. This makes a long passage for mixing the ammonia gas and the air, and the combustion gas. Accordingly, in the reformer 5, a mixing ratio of the ammonia gas and the air is equalized, which easily ignites and combusts the ammonia gas.

In the present embodiment, at a start of the reforming device 4, the ammonia gas valve 18 and the air valve 19 are controlled so as to be opened; thereafter, the ammonia gas valve 18 and the air valve 19 are controlled so as to be closed. Therefore, after the reforming device 4 starts, introduction of the ammonia gas and the air as the starter gas into the supply pipe 6 stops, which prevents excessive combustion of the ammonia gas as the starter gas.

In the present embodiment, when the temperature of the reformer 5 detected by the temperature sensor 26 becomes equal to or higher than the specified temperature T1, the ammonia gas valve 18 and the air valve 19 are controlled so as to be closed. Thus, introduction of the ammonia gas and the air as the starter gas into the supply pipe 6 stops at an appropriate timing at which combustion and reforming of the ammonia gas takes place. This can further prevent excessive combustion of the ammonia gas as the starter gas.

In the present embodiment, although the air inlets 13 are provided in the supply pipe 6, closer to the reformer 5 than the ammonia gas inlets 12 are, the configuration is not limited thereto. The ammonia gas inlets 12 may be provided in the supply pipe 6, closer to the reformer 5 than the air inlets 13 are, or the ammonia gas inlets 12 and the air inlets 13 may be provided at the same position in an axial direction of the supply pipe 6. The air inlets 13 may be provided closer to a distal end of the supply pipe 6 (closer to the igniter 11) than the gas inlets 10 are.

In the present embodiment, two ammonia gas inlets 12 and two air inlets 13 are provided in the supply pipe 6, but the number of the ammonia gas inlets 12 and the air inlets 13 is not limited to two, and may be four or one, for example.

In the present embodiment, after the starter ammonia gas and the starter air are supplied to the gas inlets 10, the main ammonia gas is supplied to the ammonia gas inlets 12, and the main air is then supplied to the air inlets 13, but the configuration is not limited thereto. A timing at which the main ammonia gas is supplied to the ammonia gas inlets 12 and a timing at which the main air is supplied to the air inlets 13 may be the same as a timing at which the starter ammonia gas and the starter air are supplied to the gas inlets 10.

In the present embodiment, when the temperature of the reformer 5 detected by the temperature sensor 26 becomes equal to or higher than the specified temperature T1 (combustible temperature), the ammonia gas valve 18 and the air valve 19 are controlled so as to be closed, but the configuration is not limited thereto. For example, when the temperature of the reformer 5 becomes equal to or higher than the specified temperature T2 (reformable temperature), the ammonia gas valve 18 and the air valve 19 may be controlled so as to be closed.

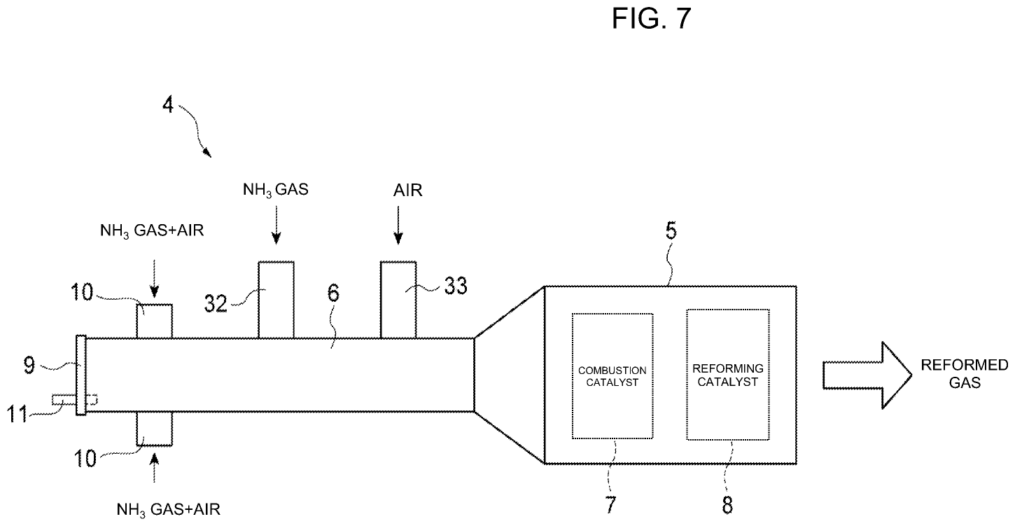

FIG. 7 is a configuration diagram of a reforming device according to a second embodiment of the present invention. In FIG. 7, a reforming device 4 of the present embodiment includes an ammonia gas inlet 32 and an air inlet 33, instead of the ammonia gas inlets 12 and the air inlets 13 of the first embodiment.

The ammonia gas inlet 32 is provided on a downstream side (on a reformer 5 side) of gas inlets 10. The ammonia gas inlet 32 extends along a radial direction of a supply pipe 6. Therefore, a starter ammonia gas is introduced into the supply pipe 6 in the radial direction of the supply pipe 6. The number of ammonia gas inlets 32 is not limited to one, and may be two or more.

The air inlet 33 is provided on a downstream side of the ammonia gas inlet 32. The air inlet 33 extends along the radial direction of the supply pipe 6, in the same manner as the ammonia gas inlet 32. Therefore, a starter air is introduced into the supply pipe 6 in the radial direction of the supply pipe 6. The number of air inlets 33 is not limited to one, and may be two or more.

In the present embodiment, it is unnecessary to introduce the starter ammonia gas and the starter air into the supply pipe 6 in a tangential direction of an inner circumferential surface 6a of the supply pipe 6. This can improve degree of freedom in designing the ammonia gas inlet 32 and the air inlet 33.

In the present embodiment, the ammonia gas inlet 32 may be provided in the supply pipe 6, closer to the reformer 5 than the air inlet 33 is, or the ammonia gas inlet 32 and the air inlet 33 may be provided at the same position in an axial direction of the supply pipe 6. The air inlet 33 may be provided closer to a distal end of the supply pipe 6 (closer to an igniter 11) than the gas inlets 10 are.

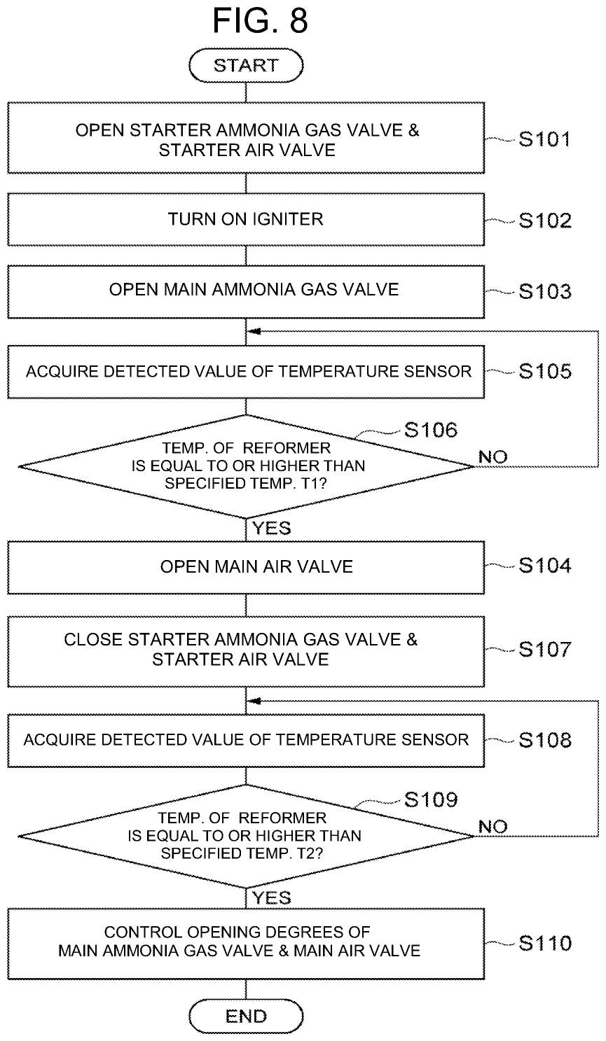

FIG. 8 is a flowchart of details of steps of a control process executed by a control unit 27 in a reforming system including a reforming device according to a third embodiment of the present invention. FIG. 8 corresponds to FIG. 5.

In the present embodiment, a reformer 5 has a combustion catalyst 7 and a reforming catalyst 8, as in the above-described first embodiment. The combustion catalyst 7 and the reforming catalyst 8 may be, for example, a cobalt-based catalyst that oxidizes at ordinary temperature and raises its own temperature.

In the present embodiment, a control unit 27 has a first controller 28 and a second controller 29, as in the above-described first embodiment.

The first controller 28 executes, at a start of a reforming device 4, a control process in which ammonia gas valves 18 and 20 and an air valve 19 are opened and an igniter 11 is turned on; thereafter, an air valve 21 is opened when the temperature of the reformer 5 detected by a temperature sensor 26 becomes equal to or higher than a specified temperature. After execution of the control process by the first controller 28, the second controller 29 controls the ammonia gas valve 18 and the air valve 19 so as to be closed.

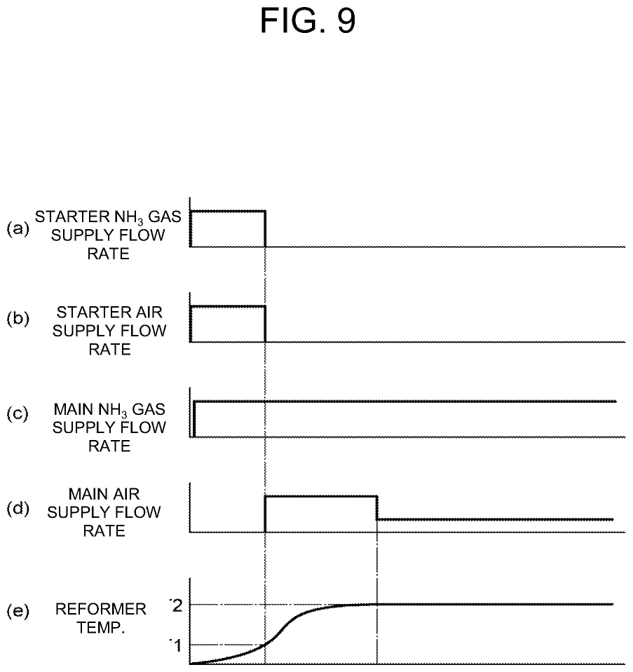

In FIG. 8, after an instruction of a start of the reforming device 4, the control unit 27 sequentially executes Steps S101 to S103 in the same manner as in the above-described first embodiment. Accordingly, starter ammonia gas is supplied to gas inlets 10 of the reforming device 4 (see FIG. 9(a)), and starter air is supplied to the gas inlets 10 (see FIG. 9(b)). Additionally, main ammonia gas is supplied to ammonia gas inlets 12 of the reforming device 4 (see FIG. 9(c)).

Next, the control unit 27 acquires a detected value of the temperature sensor 26 (Step S105). The control unit 27 determines whether the temperature of the reformer 5 is equal to or higher than a specified temperature T1 (see FIG. 9(e), Step S106). The specified temperature T1 is a combustible temperature of the main ammonia gas. When the control unit 27 determines that the temperature of the reformer 5 is lower than the specified temperature T1 (Step S106: NO), the control unit 27 executes Step S105 again.

When the control unit 27 determines that the temperature of the reformer 5 is equal to or higher than the specified temperature T1 (Step S106: YES), the control unit 27 controls the air valve 21 so as to be opened (Step S104). Accordingly, main air is supplied to air inlets 13 of the reforming device 4 (see FIG. 9(d)).

Next, the control unit 27 controls the ammonia gas valve 18 and the air valve 19 so as to be closed (Step S107). Accordingly, supply of the starter ammonia gas to the gas inlets 10 of the reforming device 4 stops (see FIG. 9(a)), and supply of the starter air to the gas inlets 10 stops (see FIG. 9(b)).

The control unit 27 sequentially executes Steps S108 to S110 in the same manner as in the above-described first embodiment.

Here, the first controller 28 executes the above-described Steps S101 to S106. The second controller 29 executes the above-described Steps S107 to S110.

In the present embodiment, the ammonia gas and the air as starter gas are introduced into the supply pipe 6 from the gas inlets 10, and the ammonia gas to be reformed is introduced into the supply pipe 6 from the ammonia gas inlets 12. After that, the air valve 21 is controlled so as to be opened when the temperature of the reformer 5 becomes equal to or higher than the specified temperature T1. Thus, even when the combustion catalyst 7 and the reforming catalyst 8 easily oxidize, the air is not introduced into the supply pipe 6 from the air inlets 13 until the temperature of the reformer 5 becomes equal to or higher than the specified temperature T1. This can prevent oxidization and deterioration of the combustion catalyst 7 and the reforming catalyst 8. When the temperature of the reformer 5 becomes equal to or higher than the specified temperature T1, the ammonia gas valve 18 and the air valve 19 are controlled so as to be closed. Therefore, introduction of the ammonia gas and the air as the starter gas into the supply pipe 6 stops at an appropriate timing of combustion and reforming of the ammonia gas. This can further prevent excessive combustion of the ammonia gas.

In the present embodiment, when the temperature of the reformer 5 becomes equal to or higher than a specified temperature T2 (reformable temperature), the ammonia gas valve 18 and the air valve 19 may be controlled so as to be closed.

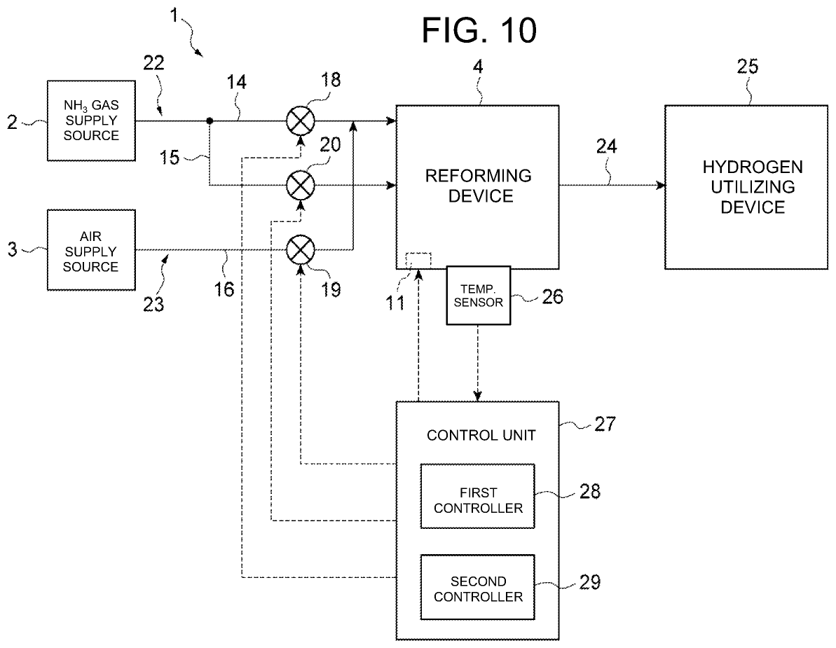

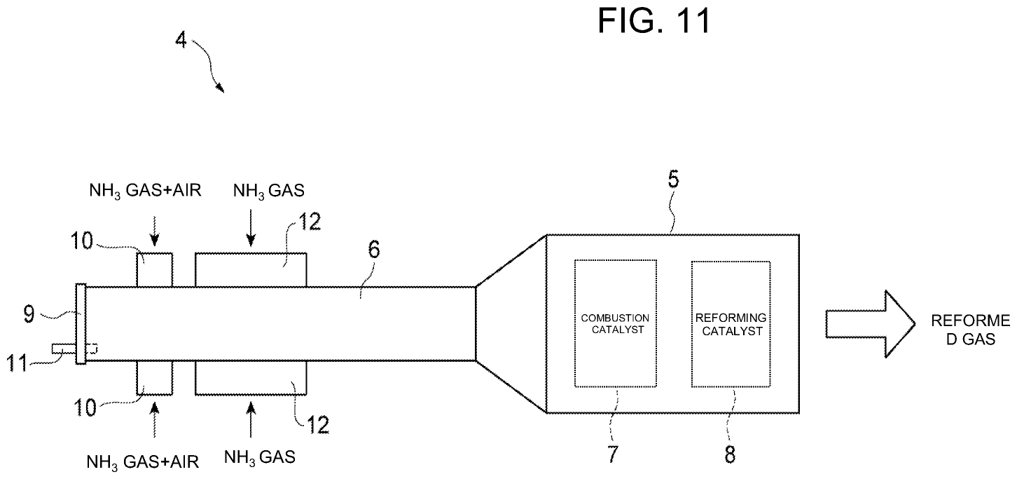

FIG. 10 is a schematic configuration diagram of a reforming system including a reforming device according to a fourth embodiment of the present invention. FIG. 11 is a configuration diagram of the reforming device according to the fourth embodiment of the present invention. In FIG. 10 and FIG. 11, a reforming device 4 of the present embodiment includes a reformer 5 and a supply pipe 6, as in the above-described first embodiment.

The supply pipe 6 has the gas inlets 10 and the ammonia gas inlets 12 of the above-described first embodiment. The supply pipe 6 does not have the air inlets 13 of the above-described first embodiment. Thus, the gas inlets 10 introduce starter ammonia gas, starter air, and main air into the supply pipe 6.

A reforming system 1 provided with the reforming device 4 includes the ammonia gas flow passages 14 and 15, the air flow passage 16, the ammonia gas valves 18 and 20, and the air valve 19 of the above-described first embodiment. The reforming system 1 does not include the air flow passage 17 and the air valve 21 of the above-described first embodiment. Thus, the air valve 19 controls flow rates of the starter air and the main air to be introduced into the gas inlets 10.

In the present embodiment, a control unit 27 controls the ammonia gas valves 18 and 20 of an ammonia gas supply unit 22, the air valve 19 of an air supply unit 23, and an igniter 11, based on a detection value of a temperature sensor 26. The control unit 27 has a first controller 28 and a second controller 29, as in the above-described first embodiment.

At a start of the reforming device 4, the first controller 28 executes a control process in which the ammonia gas valves 18 and 20 and the air valve 19 are opened and the igniter 11 is turned on. After execution of the control process by the first controller 28, the second controller 29 controls the ammonia gas valve 18 so as to be closed.

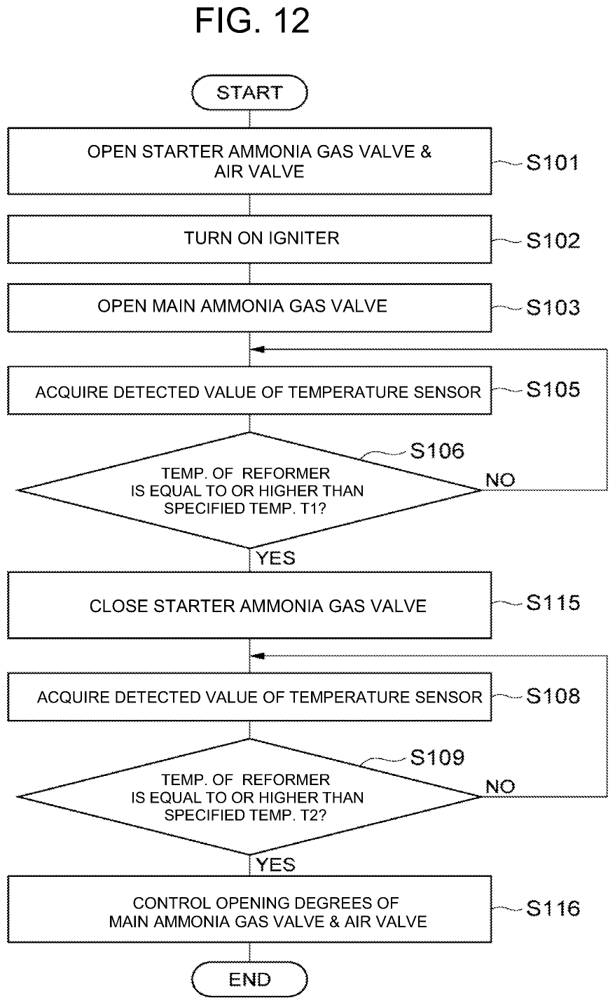

FIG. 12 is a flowchart of details of steps of the control process executed by the control unit 27 illustrated in FIG. 11. FIG. 12 corresponds to FIG. 5.

In FIG. 12, after an instruction of a start of the reforming device 4, the control unit 27 sequentially executes Steps S101 to S103 in the same manner as in the above-described first embodiment. Accordingly, the starter ammonia gas and the air are supplied to the gas inlets 10 of the reforming device 4, and the main ammonia gas is supplied to the ammonia gas inlets 12 of the reforming device 4.

Next, the control unit 27 sequentially executes Steps S105 and S106 in the same manner as in the above-described first embodiment. In Step S106, when the control unit 27 determines that the temperature of the reformer 5 is equal to or higher than a specified temperature T1 (Step S106: YES), the control unit 27 controls the ammonia gas valve 18 so as to be closed (Step S115). Accordingly, supply of the starter ammonia gas to the gas inlets 10 of the reforming device 4 stops.

Next, the control unit 27 sequentially executes steps S108 and S109 in the same manner as in the above-described first embodiment. In Step S109, when the control unit 27 determines that the temperature of the reformer 5 is equal to or higher than a specified temperature T2 (Step S109: YES), the control unit 27 controls opening degrees of the ammonia gas valve 20 and the air valve 19 (Step S116). At this time, the opening degrees of the ammonia gas valve 20 and the air valve 19 are controlled so that flow rates of the main ammonia gas and the air to be supplied are set for an appropriate reforming operation by the reformer 5.

Here, the first controller 28 executes the above-described Step S101 to S103. The second controller 29 executes the above-described Steps S105, S106, S115, S108, S109, and S116.

In the present embodiment, at a start of the reforming device 4, the ammonia gas valve 18 and the air valve 19 are controlled so as to be opened; thereafter, the ammonia gas valve 18 is controlled so as to be closed. Thus, after the reforming device 4 starts, introduction of the ammonia gas as starter gas into the supply pipe 6 stops, which can prevent excessive combustion of the ammonia gas as the starter gas. Since the air inlets 13 for introducing the air into the supply pipe 6 is unnecessary, the air valve 21 for controlling a flow rate of the air supplied to the air inlets 13 is unnecessary. This can simplify a configuration of the air supply unit 23.

In the present embodiment, a timing at which the main ammonia gas is supplied to the ammonia gas inlets 12 may be the same as a timing at which the starter ammonia gas and the air are supplied to the gas inlets 10.

When the temperature of the reformer 5 becomes equal to or higher than the specified temperature T2 (reformable temperature), the ammonia gas valve 18 may be controlled so as to be closed.

The embodiments of the present invention have been described above, but the present invention is not limited to the above-described embodiments. For example, in the above-described embodiments, the gas inlets 10 introduce the ammonia gas and the air into the supply pipe 6 in the tangential direction of the inner circumferential surface 6a of the supply pipe 6, but the configuration is not limited thereto. As long as the ammonia gas and the air are introduced into the supply pipe 6 so as to form the tubular flow, the gas inlets 10 may be displaced from the tangential direction of the inner circumferential surface 6a of the supply pipe 6.

In the above-described embodiments, although the mixed gas of the ammonia gas and the air is introduced into the supply pipe 6 from all the four gas inlets 10, the configuration is not limited thereto. For example, only ammonia gas may be introduced into the supply pipe 6 from two of the gas inlets 10, and only air may be introduced into the supply pipe 6 from the remaining two of the gas inlets 10.

In the above-described embodiments, four gas inlets 10 are provided in the supply pipe 6, but the number of the gas inlets 10 is not limited to four, and may be two or one as long as the ammonia gas and the air are introduced into the supply pipe 6.

In the above-described embodiments, when the temperature of the reformer 5 detected by the temperature sensor 26 becomes equal to or higher than the specified temperature, the ammonia gas valve 18 and the air valve 19 are controlled so as to be closed, but it is unnecessary to use the temperature sensor 26 that detects the temperature of the reformer 5. For example, the temperature of the reformer 5 may be estimated from the flow rate of the ammonia gas, the flow rate of the air, time, the room temperature, and the like.

In the above-described embodiments, although the reformer 5 has the combustion catalyst 7 combusting the ammonia gas and the reforming catalyst 8 cracking the ammonia gas into hydrogen, the configuration is not limited thereto. The reformer 5 may have a combustion reforming catalyst having a function of combusting the ammonia gas and a function of cracking the ammonia gas into hydrogen.

In the above-described embodiments, although the ammonia gas is used as fuel gas, the present invention is also applicable to a reforming device and a reforming system using hydrocarbon gas as the fuel gas, for example.

In the above-described embodiments, although the air is used as oxidizing gas, the present invention is also applicable to a reforming device and a reforming system using oxygen as oxidizing gas.

### REFERENCE SIGNS LIST

1 reforming system

4 reforming device

5 reformer

6 supply pipe

7 combustion catalyst (catalyst)

8 reforming catalyst (catalyst)

10 gas inlet (first gas inlet)

11 igniter

12 ammonia gas inlet (second gas inlet)

13 air inlet (third gas inlet)

18 ammonia gas valve (first fuel gas valve)

19 air valve (first oxidizing gas valve)

20 ammonia gas valve (second fuel gas valve)

21 air valve (second oxidizing gas valve)

22 ammonia gas supply unit (fuel gas supply unit)

23 air supply unit (oxidizing gas supply unit)

26 temperature sensor (temperature detector)

27 control unit

28 first controller

29 second controller

32 ammonia gas inlet (first gas inlet)

33 air inlet (second gas inlet)

T1 specified temperature

1. A reforming device comprising:
a reformer configured to reform fuel gas using heat generated by combustion of the fuel gas with oxidizing gas;
a supply pipe that is connected to the reformer, and through which gas containing the fuel gas and the oxidizing gas to be supplied to the reformer flows;
a first gas inlet that is provided in the supply pipe, and from which the fuel gas and the oxidizing gas are introduced so as to form a tubular flow inside the supply pipe;
an igniter that is mounted to the supply pipe, and ignites the fuel gas introduced into the supply pipe from the first gas inlet; and
a second gas inlet that is provided in the supply pipe, closer to the reformer than the first gas inlet is, and from which the fuel gas is introduced into the supply pipe.

2. The reforming device according to claim 1, further comprising
a third gas inlet that is provided in the supply pipe, and from which the oxidizing gas is introduced into the supply pipe.

3. The reforming device according to claim 2, wherein
the third gas inlet is provided in the supply pipe, closer to the reformer than the second gas inlet is.

4. The reforming device according to claim 3, wherein
the first gas inlet introduces the fuel gas and the oxidizing gas into the supply pipe in a tangential direction of an inner circumferential surface of the supply pipe.

5. The reforming device according to claim 4, wherein
the second gas inlet introduces the fuel gas into the supply pipe in the tangential direction of the inner circumferential surface of the supply pipe, and
the third gas inlet introduces the oxidizing gas into the supply pipe in the tangential direction of the inner circumferential surface of the supply pipe.

6. A reforming system comprising:
a reforming device;
a fuel gas supply unit configured to supply fuel gas to the reforming device; and
an oxidizing gas supply unit configured to supply oxidizing gas to the reforming device, wherein
the reforming device includes:
a reformer configured to reform the fuel gas using heat generated by combustion of the fuel gas with the oxidizing gas;
a supply pipe that is connected to the reformer, and through which gas containing the fuel gas and the oxidizing gas to be supplied to the reformer flows;
a first gas inlet that is provided in the supply pipe, and from which the fuel gas and the oxidizing gas are introduced so as to form a tubular flow inside the supply pipe;
an igniter that is mounted to the supply pipe, and ignites the fuel gas introduced into the supply pipe from the first gas inlet; and
a second gas inlet that is provided in the supply pipe, closer to the reformer than the first gas inlet is, and from which the fuel gas is introduced into the supply pipe.

7. The reforming system according to claim 6, further comprising
a third gas inlet that is provided in the supply pipe, and from which the oxidizing gas is introduced into the supply pipe.

8. The reforming system according to claim 7, further comprising
a control unit configured to control the fuel gas supply unit, the oxidizing gas supply unit, and the igniter, wherein
the fuel gas supply unit has a first fuel gas valve configured to control a flow rate of the fuel gas to be supplied to the first gas inlet, and a second fuel gas valve configured to control a flow rate of the fuel gas to be supplied to the second gas inlet,
the oxidizing gas supply unit has a first oxidizing gas valve configured to control a flow rate of the oxidizing gas to be supplied to the first gas inlet, and a second oxidizing gas valve configured to control a flow rate of the oxidizing gas to be supplied to the third gas inlet, and
the control unit includes a first controller configured to execute, at a start of the reforming device, a control process in which the first fuel gas valve, the first oxidizing gas valve, the second fuel gas valve, and the second oxidizing gas valve are opened and the igniter is turned on, and a second controller configured to control, after execution of the control process by the first controller, the first fuel gas valve and the first oxidizing gas valve so as to be closed.

9. The reforming system according to claim 8, further comprising
a temperature detector configured to detect a temperature of the reformer, wherein
after execution of the control process by the first controller, the second controller controls the first fuel gas valve and the first oxidizing gas valve so as to be closed when the temperature of the reformer detected by the temperature detector becomes equal to or higher than a specified temperature.

10. The reforming system according to claim 8, further comprising
a temperature detector configured to detect a temperature of the reformer, wherein
the reformer has a catalyst combusting the fuel gas, and
after execution of the control process in which the first fuel gas valve, the first oxidizing gas valve, the second fuel gas valve, and the second oxidizing gas valve are opened and the igniter is turned on, the first controller controls the second oxidizing gas valve so as to be opened when the temperature of the reformer detected by the temperature detector becomes equal to or higher than a specified temperature.

11. The reforming system according to claim 6, further comprising
a control unit configured to control the fuel gas supply unit, the oxidizing gas supply unit, and the igniter, wherein
the fuel gas supply unit has a first fuel gas valve configured to control a flow rate of the fuel gas to be supplied to the first gas inlet, and a second fuel gas valve configured to control a flow rate of the fuel gas to be supplied to the second gas inlet,
the oxidizing gas supply unit has an oxidizing gas valve configured to control a flow rate of the oxidizing gas to be supplied to the first gas inlet, and
the control unit includes a first controller configured to execute, at a start of the reforming device, a control process in which the first fuel gas valve, the second fuel gas valve, and the oxidizing gas valve are opened and the igniter is turned on, and a second controller configured to control, after execution of the control process by the first controller, the first fuel gas valve so as to be closed.
